(19) United States
(12) Patent Application Publication
(10) Pub. No.: US 2024/0262399 A1
(43) Pub. Date: Aug. 8, 2024

(54) DISTANCE OPTIMIZATION DEVICE FOR A CONVEYOR SYSTEM, METHOD FOR CONVEYING OVERHEAD TRANSPORT ELEMENTS AND OVERHEAD CONVEYOR SYSTEM

(71) Applicant: FERAG AG, CH-8340 HINWIL (CH)

(72) Inventor: Roberto FENILE, Wetzikon (CH)

(73) Assignee: FERAG AG, CH-8340 HINWIL (CH)

(21) Appl. No.: 18/430,824

(22) Filed: Feb. 2, 2024

(30) Foreign Application Priority Data
Feb. 3, 2023 (CH) 000097/2023
Jan. 30, 2024 (EP) 24154861.9

(51) Int. Cl. B61L 27/20; B61B 3/00; B61L 25/02

(52) U.S. Cl. CPC B61L 27/20; B61B 3/00; B61L 25/025

(57) ABSTRACT

A distance optimization device (20, 20a-20e) for overhead transport elements (23, 23a-23e), in particular within an overhead conveyor (22), includes at least one sensor unit (21), at least one distance adjustment element (27), and at least one control unit (39). The at least one control unit is designed to control the at least one distance adjustment element on the basis of measurements of the at least one sensor unit of the free space between two adjacent overhead transport elements (23, 23a-23e), so that the distance between the adjacent overhead transport elements (23, 23a-23e) is adjusted in an adaptable and parametrized manner.

### CROSS REFERENCE TO RELATED APPLICATIONS

This patent application claims priority to Swiss Patent Application No. CH 000097/2023, filed 3 Feb. 2023 and European Patent Application No. EP 24154861.9, filed 30 Jan. 2024. The aforementioned priority documents, corresponding to this invention, to which a foreign priority benefit is claimed under Title 35, United States Code, Section 119, and Title 37, United States Code, Section 1.55, and their entire teachings are incorporated, by reference, into this specification.

The above-referenced applications are hereby incorporated by reference herein in their entirety and are made a part hereof, including but not limited to those portions which specifically appear hereinafter.

### BACKGROUND OF THE INVENTION

### Field of the Invention

The present invention relates to a distance optimization device, a method for conveying overhead transport elements, and an overhead conveyor system for overhead transport elements.

### Discussion of Related Art

In modern dynamic intralogistics, conveyor systems, production facilities, warehouses, order picking systems and other logistics systems are being assigned increasingly complex operating requirements, meaning that complex system technology is usually unavoidable to meet these requirements. In order to meet the increasing processing capacities and counteract the rise in operating costs, the systems are also operated at high conveying velocities. However, the high conveying velocities are associated with a further problem, namely conveying instabilities and a higher risk of collision between the items to be conveyed or items and their transport units, and consequently with greater susceptibility to disruption of the orders, capacity overloads, delays or even a standstill of the system.

Of the tried and tested conveyor systems, overhead conveyor systems in particular have proven to be an efficient means of transporting, buffering and long-term storage of various types of items. Items are understood to be a wide variety of goods that are provided as part of order picking for shipping systems or industrial manufacturing in production. The term unit load is also regularly used, whereby these are conveyed individually or in groups. In overhead conveyor systems, the items are either attached directly to individual conveyor elements of a conveyor system in a suitable manner or placed in corresponding transport elements, such as in particular overhead transport elements, which in turn are arranged overhead on the conveyor elements. Overhead conveyor systems can be realized as transport chain systems, in which a plurality of conveyor elements are designed in particular as links of a chain, as carriers or chain-conveyed running elements, which are moved along a conveyor section. Within the scope of the invention, however, other, e.g. rail-guided, active (driven) or passive (gravity conveying) conveyor systems with flexibly spaced or intermittent overhead transport elements can also be used.

In addition to the classic use in logistics facilities, there are also other possible applications where the alternative in the form of human labor is impossible or very difficult to implement, such as the transport of objects in hazardous environments or at extreme temperatures. Examples of such operations are refineries or chemical processing plants. For this purpose, the overhead conveyor system, including the transport elements and other components, can be designed to be fire-resistant and alternatively or additionally corrosion-resistant in accordance with the invention. Particularly in such applications, it is important that operation is as trouble-free and collision-free as possible.

In overhead conveyor systems that operate at high conveying velocities, the overhead transport elements are generally subjected to high loads resulting from the complex geometry of the system and the system performance. Due to their operational requirements, modern systems regularly have complex, logistics-optimized geometries, with various vertical and horizontal conveyor levels and a system of curved conveyor tracks. The overhead transport elements must therefore be stopped, guided around curves and accelerated or decelerated more frequently during conveying or storage or buffering. As a result, the overhead transport elements are pivoted relative to their rest position, start to vibrate or move in other ways and can collide with other overhead transport elements. This leads to a very special problem with overhead conveyor systems compared to other conveyor systems. Depending on the overhead transport elements used, especially when flexible overhead transport elements are used, these can change their external and internal geometry or expansion, in particular their volume, due to the conveying (mutual displacement of the items within the transport element due to the forces of movement acting on them) or given processing steps (e.g. sequential filling or removal of products).

The basic concept of an overhead conveyor consists of a system of plant structure, controls, belts, chains or rails, switches and rollers, as well as conveyor units that are moved by means of drives or gravity. The overhead conveyor is positioned above the floor (often also above the head of a work area), with items being transported from one point to another. This type of conveyor system can also be used for buffering or storing items. Specifically, they are used, for example, to automate the packaging and shipping of products. In addition, this enables more efficient use of space and the ability to quickly provide and organize consignments in shipping systems as required.

Due to these requirements and the existing movement dynamics, the items to be conveyed, the transport elements or even the system itself can be impaired or damaged. If these effects are not taken into account, trouble-free operation at high velocities and high conveying capacity cannot be guaranteed.

EP 3543181 A1 of the present applicant is known from the prior art. It describes a conveying device for indexing transport units, with a plurality of transport units and an indexing or circulating conveyor for conveying the transport units. The cycle conveyor there comprises a plurality of carriers, each of which can be detachably connected to a transport unit, as well as at least one conveyor section and a switch device. The conveyor sections are connected to the cycle conveyor at a synchronization point, which is set up to synchronize the transport units into the cycle conveyor at the synchronization point. Various detection devices are provided in the area of the conveyor sections, which determine the expansions of the transport units and set the desired conveying distances of the transport units based on this using a control system or controlled separation devices. Optimization of the conveying distances is only possible here indirectly by determining the expansion of the transport units.

DE 102019215304 B3 is also known from the state of the art. This document discloses a device and a method for feeding overhead conveyed items individually into a conveyor system of an overhead conveyor system. The transport distance of the overhead conveyed items on the conveyor system can be variably determined, wherein a feeding unit with stop elements is provided for stopping the overhead conveyed items so that a detection unit can detect the thickness of the individual overhead conveyed items. The transport distance of the overhead transport items can then be adjusted taking into account the thickness of the individual overhead transport items by means of the stop element of the feed unit. According to this document, the thickness of the overhead transport items is recorded after the overhead transport items have been stopped. Other parameters of the system and the overhead transport elements are not taken into account and the design can only be used for linear, very simple conveyor sections. For example, an inclination, the angular position of the overhead transport elements, a curved course of the conveyor track or oscillation of the overhead items during conveying are not taken into account at all. Here too, the conveying distance can at best be determined indirectly (and with errors) by measuring the thickness at certain points. An optimized conveying density can therefore not be achieved, as the thickness measurement of the overhead transport elements is not sufficient to meet dynamic and more complex operating conditions and to include non-linear system geometries. This design also does not take into account the movement tolerances of the overhead conveyed items, which means that it does not meet the requirements of modern complex overhead conveyor systems.

Also in another previously known solution according to EP 2899144 A1, which provides a conveyor device for the automated conveying of individual items along a conveying direction designed as an overhead conveyor device and has adapter identification means on adapters for picking up the individual items and individual items transponders on the individual items, wherein a transponder reading unit for reading the data of the transponder and the identification means are in signal connection with a control unit, and these data are linked, both the sensor system and the control system are not sufficient to bring about safe operation of a complex system and an optimized conveying density.

A further application of the present applicant, CH 714004 A1, shows a picking system for picking different items, in particular items which can be transported overhead, which comprises at least one feeding station with a plurality of feeding stations arranged in parallel for feeding the items to be picked into the picking system, as well as at least one dispatch station with a plurality of dispatch stations arranged in parallel for delivering the picked items to the dispatch department. The present invention shows a more complex system technology for picking the items, wherein at least one intermediate store is provided between the loading station and the dispatch station. A high throughput is achieved with a simultaneous reduction in the amount of equipment required, in that the at least one intermediate store comprises a dynamic store for intermediate storage of the items provided for order picking and a retrieval store connected downstream of the dynamic store for storing items that have been retrieved from the dynamic store and presorted in the process, which are arranged within a common circulating conveyor and are connected to one another via the common circulating conveyor. A stop mechanism is then provided at the exit of each of the storage sections, which stops the downward movement of the items and separates them for retrieval and feeds them into the recirculating conveyor via corresponding infeed diverters. Optimization of the conveying density, taking into account the distances between the transport units and including the trajectories in the conveying areas in terms of control, is not described there.

JP H05/42074 U discloses an automatic adjustment device for managing the distance between carriers on assembly lines for vehicles. This device adjusts the inter-vehicle distance dynamically, responding to the length of the objects being transported. Traditional systems maintained a fixed distance between vehicles and needed manual intervention for adjustments, posing efficiency and safety challenges. The disclosed device employs sensors and reflective elements to detect the distance and adjust it according to the length of the object, which aims to ensure more optimal spacing, preventing collisions and material contact. The device is specifically tailored for assembly line carriers for vehicles. The device lacks flexibility in regard to different transported items, for example items with different shapes or materials, and depends on a specific infrastructure. Although automated, the device can require manual intervention in disruptive situations and cannot provide real-time space optimization, which limits efficiency and adaptability in dynamic operational conditions, as they are often encountered in logistics systems.

There is a general need for improvement in this field of technology.

### SUMMARY OF THE INVENTION

The present invention aims to provide a solution which counteracts the disadvantages of the state of the art at least in certain areas and which enables an optimized conveying density and collision-free operation of even complex storage and conveying systems.

In addition to taking into account the specific disadvantages of the state of the art mentioned above, an increase in the conveying capacity in a conveyor system for overhead transport elements is planned and the shipping arrangement of the conveyor system in this area should also be improved as far as possible.

These and other problems are solved by the features of the independent patent claims.

These and other objects are substantially achieved by a distance optimization device, a method for conveying overhead transport elements, and an overhead conveyor system for overhead transport elements, according to the independent claims. Further advantageous embodiments follow from the dependent claims and the description.

The solution according to the invention can be further improved by various embodiments, each of which is advantageous in itself, and, unless otherwise specified, can be combined with one another as desired. These embodiments and the advantages associated therewith are discussed below.

A first aspect of the invention concerns a distance optimization device for overhead transport elements, in particular of an overhead conveyor system.

A distance optimization device according to the invention comprises at least one sensor unit, at least one distance adjustment element and at least one control unit. The at least one control unit is designed to control the at least one distance adjustment element on the basis of measurements by the at least one sensor unit of the free space between two adjacent overhead transport elements, so that the distance between adjacent overhead transport elements can be adjusted in an adaptable and parametrized manner.

The aforementioned overhead transport elements are a central component of an overhead conveyor in, at or on which overhead items are transported from one point to another. The overhead transport elements are adapted to the overhead items to be conveyed in the system. In addition to transport bags, clothes hangers (if items of clothing are to be conveyed or picked) or, in particular, transport racks or grippers are also used as overhead transport elements. Furthermore, fillable containers or adapter elements such as eyelets, hooks or grippers can also be used as hanging transport elements.

Advantageously, these adapter elements are controllable so that they allow the release of conveyed items during desired processing steps or also allow release by the control unit in disruptive situations or for local optimization of the conveying distance.

Alternatively, or additionally, the at least one control unit is designed to control the at least one distance adjustment element on the basis of measurements of the at least one sensor unit of the free space between two adjacent conveyor elements, so that the distance between the adjacent conveyor elements can be adjusted and parameterized.

The present distance optimization device makes it possible not only to keep the filling volume of the overhead transport elements optimized, but also to improve the density of the overhead transport elements used during their conveying, buffering or storage in the system. The invention thus aims to achieve a system-optimized or system-controlled spacing of the overhead transport elements, which is also referred to here as optimizing the conveying density.

In overhead conveyor systems of the type already mentioned, it is necessary to align or arrange the overhead transport elements along the conveyor line according to requirements in terms of their mutual spacing and alignment, in particular also in the case of different path curves, in order to be able to improve them. With an improved conveying density, the highest possible conveying capacity can be achieved with minimal risk of collision and less susceptibility to faults. In addition to the (variable) geometry of the overhead transport elements, a particularly difficult aspect of achieving an optimized conveying density is the consideration of the system geometry.

Ideally, the conveying density can be dynamically adapted to the changing course of the conveyor line, as the optimized conveying density differs depending on the trajectory of the overhead conveyor (straight line, curve, incline, etc.). With this in mind, we refer to the trajectories of the conveyor sections (or buffer or storage sections). An optimized conveying density and safety tolerances for curves can be determined, for example, from the curvature of the curve (and alignment of the overhead transport elements), whereby the conveying velocities must be taken into account.

Advantageously, the overhead transport elements have adapter elements that serve as a connecting element between overhead transport elements or overhead transport items and the conveyor elements of the conveyor system. This allows the overhead transport elements to be easily mounted on the conveyor system so that they can be moved.

Advantageously, the adapter elements can also be height-adjustable. This also allows the distance between the individual overhead transport elements to be reduced, as the height of an overhead transport element can be adjusted so that the widest or most voluminous area of this overhead transport element correlates in height with the thinnest or most space-saving area of the adjacent overhead transport element. The overhead conveyors could also take advantage of advanced AI to predict the transport flows of the transported overhead items, identify capacity bottlenecks and reduce energy consumption. This can be done on the basis of the items such as products and goods loaded in the overhead transport elements and the technical specifications of the loading and unloading stations.

In addition, these devices can be integrated into the overall system as part of the overhead conveyors so that the transportation of the overhead transport elements takes into account their loading and unloading capabilities and capacities. Even when using AI-based systems and durable materials, a disruptive collision between two overhead transport elements can occur, which can damage or wear out the transport product, which in extreme cases can lead to the standstill of conveyor sections or the entire overhead conveyor. According to the invention, such problem areas should be avoided as far as possible or identified as quickly as possible, which can be time-consuming, especially in large overhead conveyor systems or rooms. At this point, extended reality can also be consulted in addition to the design and conveying measures. A technician who identifies a point on the overhead conveyor that may cause a malfunction, or a stop can use this technology (e.g. glasses comprising an augmented reality application, or imaging tablet or holography) to identify corresponding positions or areas and/or determine the necessary conveying distances at these points.

Particularly advantageously, a simulation or visualization of a 3D model of the overhead conveyors with overhead transport elements can also be used in real time to support the optimization of conveying distances, if necessary, with visualization of the items transported by means of the overhead transport elements, which contributes to the optimization of the loading and unloading of the overhead transport elements.

For special applications, at least one adapter element (and/or overhead transport element) advantageously comprises a shock-absorbing material or structural element to reduce the movement impulses caused by the movement of the overhead transport elements by means of a conveyor, in particular when changing direction or when ascending and descending conveyor sections. Alternatively, a shock-absorbing part can be inserted between the adapter element and the overhead transport elements. In order to increase the conveying density of the overhead conveyor, it is also advantageous to equip it with flexible overhead transport elements.

These measures make it possible to adjust the overhead transport elements to different lengths and widths during loading, so that the overhead transport elements can be better adapted to the transportation of items of different shapes and weights. For example, the overhead transport elements can be adapted by adding or removing components such as zippers, Velcro fasteners, straps or other mechanisms, with the aim or effect of conveying the transport units as smoothly as possible.

Advantageously, at least one adapter element for measuring the weight of the overhead transport elements loaded with overhead transport items or a stationary weight measuring unit is provided.

A load cell can be arranged on the adapter element. The load cell is a device that converts the weight of the overhead transport elements into an electrical signal, which can then be displayed on a digital display, read out or transmitted to the first computation unit or the control unit for recording and analysis. Weight measurement is advantageous to achieve continuous and accurate monitoring of the weight of the overhead transport elements being conveyed, which is useful for quality control and inventory management. It also helps to improve the safe and efficient operation of the overhead conveyor system, as overloading individual overhead transport elements can lead to damage or downtime. Based on the corresponding measurement, commissions can be automatically distributed to several transport elements in a controlled manner. In addition, this measure can provide control-relevant data for optimizing the design and operation of the overhead conveyor system, e.g. by identifying bottlenecks or inefficiencies in the control unit itself.

It is advantageous for special systems to equip the overhead transport elements, the conveyor or adapter elements themselves with sensors which, in addition to the weight, monitor the dynamic forces during transport of the overhead transport items or reduce the risk of damaging sensitive items during transport, in particular fragile items such as glass, food or sorted transport or items units. To minimize this risk, the overhead transport elements can advantageously be provided with locks, clamps or latching elements that hold the items in place. The overhead transport elements and/or the conveyed items could be equipped with labels or electronically readable chips (e.g. RFID) for tracking, further processing and inventory.

To convey special items, an overhead transport element or an overhead conveyor can consist of several compartments or sections that allow the transported items to be specifically arranged or sorted within them.

In particular, two or more overhead transport elements can be connected to each other. These (or their compartments) can be arranged vertically one above the other and assigned to the same conveyor element. Furthermore, they can alternatively or additionally be mutually aligned in such a way that one overhead transport element (or its compartment) is arranged in the conveying direction and the other (or its compartment) is arranged against the conveying direction. These options are primarily dependent on the design of the overhead transport element loaded with items to be conveyed or the items to be conveyed. Another option is to arrange two or more overhead transport elements (or their compartments) side by side.

This solution has the advantage of increasing productivity, as the transported items with similar characteristics and dimensions are placed in different compartments, which facilitates their subsequent sorting at removal points. In addition, the conveying volume can be optimized during transport, as more products can be added to the individual overhead transport elements, thus also increasing the conveying density or capacity. Another important aspect of the overhead transport elements is the material from which they are made. The more durable the material is, the longer an overhead transport element can be in use and the more load it can carry, for example up to 25 kg or more. Such materials include Kevlar, canvas or polypropylene.

Advantageously, the overhead conveyor itself is made of lightweight materials such as aluminum or composite materials, which allows for greater flexibility and easier handling when they need to be frequently assembled and disassembled.

In this respect, thanks to the high degree of automation of the control unit, their use can be imagined not only as fixed units in a warehouse or factory, but as modular units that can be quickly brought to the place of need, assembled and disassembled.

The distance optimization device is used to optimize the conveying of overhead transport elements per time unit, depending on the size of the distance between the individual overhead transport elements. The distance optimization device makes it possible to minimize the distances between them as much as possible in order to increase the conveying density. Nevertheless, sufficiently large distances should be determined in order to avoid unwanted collisions between individual overhead transport elements. This is advantageous in order to minimize the wear of these overhead transport elements and to prevent the risk of damage to the overhead items or items being transported in the overhead transport elements and to avoid malfunctions.

The distance optimization device can also be used to prioritize overhead conveyed items. This is particularly advantageous if an overhead conveyor system contains more than one loading station or several merged conveyor sections. In this case, for example, one or more of the overhead transport items of a first loading station or conveyor section can be assigned a higher priority than those of the second. In this way, sufficient free space can be created in the conveyor flow for overhead transport elements carrying the prioritize overhead conveyed items. This setting is flexible and can be adapted to current requirements at any time.

In particular, at least one separating device controlled according to the invention can be arranged along the conveyor sections as a distance optimization device, particularly advantageously after each loading station. The separating device advantageously has a stop/release unit for the conveyor units or can additionally or alternatively contain a braking/acceleration unit for the latter.

The solution according to the invention can be supplemented and further improved by the following further embodiments, each of which is advantageous in its own right.

According to one advantageous embodiment, the at least one sensor unit is designed to measure at least one clear dimension between adjacent overhead transport elements or conveyor elements.

In simple terms, the free space between two overhead transport elements or conveyor elements in their static or moving hanging position during transport is used to determine the clear dimension.

Measuring at least one clear dimension makes it possible to recognize information indicative of the distance between adjacent overhead transport elements, with which the distance between adjacent overhead transport elements can be determined in the at least one control unit or measured directly. According to the invention, the term clear dimension is understood to mean indicative information for the distance between at least two overhead transport elements, in the sense of a line, an area or also a volume. Which of these three methods is advantageous depends on the complexity of the volume or space between the overhead transport elements and the embodiment of the at least one sensor unit and can therefore also be selected with the aid of the type or structure of the at least one sensor unit. In addition, adjacent overhead transport elements do not necessarily include overhead transport elements that are arranged directly next to each other, but also overhead transport elements that are located in mutual transport proximity to the conveyor system (e.g. in the case of switches or crossings of conveyor lines).

In a further advantageous embodiment, alternatively or additionally, the at least one sensor unit is designed to determine at least one position of at least two adjacent overhead transport elements and/or conveyor elements.

The detection of the position of at least two adjacent overhead transport elements comprises information indicative of the distance between adjacent overhead transport elements, with which the distance between adjacent overhead transport elements can be determined in the at least one control unit. The distance between two conveyor elements or the distance between an overhead transport element and a conveyor element can also be used for this purpose. In particular, if the volume of a trailing overhead transport element or the volume of the overhead material on the overhead transport element is known, an optimized distance to the leading overhead transport element can be set in a targeted manner. The detection of at least one clear dimension and at least one position of at least one overhead transport element and/or conveying element enables further optimized adjustment of the spacing of the overhead transport elements and/or overhead transport elements, so that the conveying density in an overhead conveying system is further increased.

According to a further advantageous embodiment, it is provided that the at least one clear dimension minimum between adjacent overhead transport elements is a minimum value distance between said adjacent overhead transport elements.

The clear dimension minimum refers to the minimum value of the measured clear dimension between adjacent overhead transport elements. The advantage of using this minimum value distance is that the risk of possible collisions between individual overhead transport elements is minimized when conveying in the conveyor system. This ensures safe and gentle conveying of the overhead transport elements in the conveyor system.

If a distance were permitted that corresponds to the average of all values of at least one clear dimension or even its maximum value between overhead transport elements, there would be a risk of collision in the conveyor system, especially at those points where the clear dimension is smaller than the permitted distance. Furthermore, the clear dimension minimum between two adjacent overhead transport elements along the conveyor line is not constant, but usually changes depending on the trajectory of the overhead conveyor (e.g. in curves). For this reason, the clear dimension minimum can be described as a function of two adjacent overhead transport elements and their respective trajectory position. If two adjacent overhead transport elements are understood as a logical group, their clear dimension minimum can be described in a simplified manner as a function of the clear dimension and the respective trajectory area or trajectory position, i.e.

$$Clear dimension minimum = f ( clear dimension of adjacent \\ overhead transport elements , trajectory position ) .$$

The aforementioned parameterized setting of the distance between adjacent overhead transport elements means that the conveying distance is adapted and determined directly as a function of the clear dimension or the clear dimension minimum, taking into account trajectory positions. The considerably less accurate and yet complex measurement of the thickness or the expansion of transport units or the transported items within the overhead transport elements is therefore not used. The setting of the distance according to the invention is parameterized because the target distance (clear dimension minimum or clear dimension minimum with safety margin) is measured or calculated directly as a function of the clear dimension and the trajectory positions, which then specifies the conveying distances of the overhead transport elements (and thus the conveying density) as a control variable. The control variable can act directly on the conveyor elements or adapter spacings or the corresponding control devices, such as a separation unit in particular, and set the desired spacings.

In the case of particularly complex systems, further optimization for determining the clear dimension minimum can alternatively be achieved by taking into account other overhead transport element properties. In these cases, the clear dimension minimum is determined as follows:

$$Clear dimension minimum = f ( clear dimension of adjacent \\ overhead transport elements , trajectory position , \\ overhead transport element properties )$$

The determination of an extended clear dimension minimum in accordance with this variant of the invention makes it possible to take into account further properties of the overhead transport element, such as its weight or the material from which it is made, or also the items conveyed within it, which has an effect, among other things, on the adaptability of the overhead transport element to the overhead conveyed items with which it is loaded.

According to a further advantageous embodiment, at least one compaction device is provided.

The at least one compaction device is used to optimize and/or fix the position or arrangement of the overhead transport items in the overhead transport elements. The at least one compacting device can, for example, be designed to move, shake or vibrate overhead conveyor goods in, on or at the overhead transport elements in order to compact them so that they are arranged more densely and with a reduced volume. Other supplementary mechanisms, e.g. compression brushes, are also advantageously usable in order to arrange the overhead transport items in the overhead transport elements in an optimized manner.

Particularly advantageously, the at least one compaction device is positioned in front of the at least one sensor unit along a conveying direction of the overhead conveyor.

With the aid of the at least one compaction device, the probability of the overhead transport items changing their position in the overhead transport elements in an undesired manner during further conveying is thus minimized. This is advantageous because the clear dimension between the overhead transport elements is less susceptible to changes, for example due to tilting or swinging of the overhead transport elements, after loading with the overhead transport items. In addition, it also has the positive effect of reducing the need for sensor units to measure the clear dimension along the overhead conveyor. In favorable cases, it is only necessary to measure the clear dimension in the conveyor system once, immediately after the aforementioned compaction device or a loading station. However, it is advantageous to provide the overhead conveyor with several sensor units and thus increase the robustness of the entire conveyor solution.

According to a further advantageous embodiment, at least one identification means is provided, wherein the at least one identification means assigns at least one identification feature to at least one overhead transport element or conveyor element along the conveying direction of the overhead conveyor.

The at least one identification means is used to identify the individual overhead transport elements. The at least one identification means can be a scanner or a marker, or a combination of a scanner and a marker. A scanner can recognize identification features and, if necessary, forward them to the control unit. A marker marks a hanging transport element with at least one identification feature so that it is fixed there. Advantageously, at least one identification feature is assigned to each overhead transport element. For example, a number, an RFID tag or a QR code can be used as an identification feature, whereby it is particularly advantageous if this feature is unique for each overhead transport element or conveyor element. This makes it possible to identify each overhead transport element or conveyor element and associate it with specific properties, such as the weight, type or fragility of the loaded overhead transport items, or the size of the overhead transport element. The at least one identification feature can also contain a time stamp to store a time at which an overhead transport element or conveyor element left a loading station. For example, the conveying time of the overhead transport items in the conveyor system can thus be determined, which is particularly advantageous for perishable overhead transport items. All this information is advantageous because it leads to better tracking of both overhead transport elements and overhead transport items and can be used to optimize the conveying density.

The at least one identification means can also be used to monitor and control the load on the overhead transport element or the conveyor element over time. The time that the overhead transport element spends on conveying overhead transport items (integrated) can be recorded and assigned to the at least one identification means. At the same time, the person skilled in the art knows the time after which the overhead transport element is worn to such an extent that it is advantageous to maintain it. This time can be described as the critical operating time. Thanks to this solution, it is possible to automate the maintenance control of the overhead transport elements, for example by automatically signaling the imminent end of the critical operating time of the overhead transport element. In particular, this makes it possible to prevent an overhead load from being affected by severe damage to the overhead transport element by exceeding the critical operating time of the overhead transport element.

According to a particularly advantageous embodiment of such a device, the at least one identification means assigns to the at least one identification feature of the overhead transport element or conveyor element a distance to at least one adjacent overhead transport element or conveyor element.

This makes it possible that it is not necessary to measure the at least one clear dimension between adjacent overhead transport elements or conveyor elements after each distance adjustment by means of the at least one distance adjustment element in order to determine the distance, but to calculate it by means of software in a computer device. This simplifies and reduces the cost of the entire conveyor technology. However, it is advantageous to set up several sensor units along the conveyor system with which changes in size in or on the overhead transport elements, e.g. due to the overturning of the overhead transport items, can be determined. Last but not least, the adjacent overhead transport elements are divided into two categories, namely leading and trailing overhead transport elements, relative to the overhead transport element in question. The decision as to which distance, or whether several distances, are to be used in the identification features depends on the respective application in the conveyor system.

According to a further advantageous embodiment, at least one distance between adjacent overhead transport elements is dependent on a trajectory of the overhead conveyor.

In particular, the at least one distance between adjacent overhead transport elements can be the clear dimension minimum.

The trajectory of the overhead conveyor is to be understood as its 3D design or the course of its conveyor lines. The trajectory includes, for example, straight sections and curves that are at the same height but can also include sections that vary in height. This trajectory is advantageously taken into account when optimizing the distance between adjacent overhead transport elements. For example, the distance optimized on a straight section in a curve can be too small due to the rotation of the overhead transport elements relative to each other on the inner radius, which can lead to collisions between the overhead transport elements or the overhead items. Such a collision is particularly possible if the overhead transport elements have different widths or large depths. The same applies to the sections in which the height of the overhead transport elements changes relative to the floor, especially if the at least one clear dimension between adjacent overhead transport elements differs in their vertical direction.

According to a further advantageous embodiment, alternatively, or additionally, at least one distance between adjacent conveyor elements is dependent on a trajectory of the overhead conveyor.

In particular, the at least one distance between adjacent conveyor elements can be the clear dimension minimum.

For example, collisions of conveyor elements may occur in those sections where the height of the conveyor elements relative to the ground changes, particularly in the case where the at least one clear dimension between adjacent conveyor elements differs in their vertical direction.

Advantageously, at least one distance between adjacent overhead transport elements depends on at least one dimension of the overhead transport element.

Thicker or wider overhead transport elements or thinner and narrower overhead transport elements require a different distance from an adjacent overhead transport element. The at least one sensor unit can be designed to detect at least one dimension of the hanging transport element. It is particularly advantageous that the width, i.e. a dimensioning of the overhead transport element perpendicular to the direction of travel, can be detected by the at least one sensor unit, so that at least one distance can be set in relation to the width of the overhead transport element. This improves the conveying of the overhead transport elements in the curves of the trajectory and avoids unwanted collisions in the curves.

According to a further advantageous embodiment, a first computation unit is provided.

The first computation unit is connected to the at least one sensor unit for exchanging data or measurement data. The first computation unit receives the measurement data from the at least one sensor unit and uses a calculation model to easily and reproducibly calculate at least one optimized distance between adjacent overhead transport elements or conveyor elements. The first computation unit is connected to the at least one control unit for exchanging control data in order to control the at least one distance adjustment element in such a way that the calculated optimized distance between adjacent overhead transport elements or conveyor elements can be adjusted. This allows a conveying density to be increased.

According to a particularly advantageous embodiment of such a device, the first computation unit is designed to calculate at least one optimized distance based on the trajectory of the overhead conveyor.

The first computation unit receives the measurement data from the at least one sensor unit and uses a calculation model to easily and reproducibly calculate at least one optimized distance based on the trajectory or a partial trajectory of the overhead conveyor. For example, the first computation unit calculates an optimized distance between overhead transport elements on the basis of the at least one light measurement measured by the at least one sensor unit. Furthermore, the distance is a parameter that is optimized to achieve the highest possible conveying density while minimizing the risk of collisions between overhead transport elements. The parameters of the calculation model can include, for example, the dimensions of the overhead transport element, its dimensions, velocity, acceleration and its center of mass.

Alternatively, or additionally, in a particularly advantageous embodiment of such a device, the first computation unit is designed to calculate at least one optimized distance based on the velocity of at least one overhead transport element.

This takes into account, for example, height-changing sections of the trajectory as well as rocking or pivoting of the overhead transport items or the overhead transport elements in order to prevent a collision and still achieve an optimized conveying density on the conveyor system. Finally, one of the reasons why overhead transport elements can collide is the acceleration of the overhead transport elements, for example when leaving a loading station or a distance adjustment element. This acceleration, together with the weight of the overhead transport element and the weight distribution over the length of the overhead transport element, influences its inclination in the direction of travel. It is therefore advantageous to take this characteristic into account when determining the optimum distance between the overhead transport elements by the first computation unit. Thanks to the minimization of collisions between the overhead transport elements, their increased wear and possible damage to the overhead transport items can be avoided or at least reduced.

Advantageously, an artificial intelligence (AI) module is connected to the first computation unit or integrated therein in order to set at least the optimized distance between adjacent overhead transport elements or conveyor elements or to control the conveyor paths in such a way that optimized conveyor capacities are provided.

The AI receives data from the at least one sensor unit, for example. The AI can also receive data from the at least one identification means in order to be able to output at least the optimized distance between adjacent overhead transport elements. The AI can be trained with training data, whereby the training data can comprise identification features for individual overhead transport elements or also measurement data from the at least one sensor unit. In particular, the training data can also include historical data that was created when the conveyor system was commissioned, for example. This allows the AI to be trained with data from the same conveyor system, enabling rapid learning.

According to a further advantageous embodiment, the at least one sensor unit is designed to detect a dynamic spatial form of the overhead transport elements.

Alternatively, or additionally, further advantageous embodiment a dynamic spatial form of the overhead transport elements can be calculated by the control unit or the first computer device.

For example, the dynamic spatial of the overhead transport elements from the measurement data of the sensor unit and/or other control information (e.g. historical data or advantageously default data for the overhead transport elements).

The dynamic spatial form of an overhead transport element is understood here as the determined or calculated spatial geometry, which comprises the geometry of this overhead transport element including its maximum dynamic deflections during conveying (including its enclosed items or its maximum volume), advantageously at least its swivel movements in and against the conveying direction. The outer surface of the dynamic spatial form determined in this way for each two adjacent overhead transport elements allows the clear dimension between them to be determined. The deflections are caused by the movement of the overhead transport elements, such as rocking, pivoting or twisting, or an inclination of these. In this way, a guidance control or data-supported local control of separation units determines an optimized, minimum spacing of the overhead transport elements downstream. Taking dynamic spatial form detection into account is particularly advantageous because the overhead transport elements do not have to be stopped for the measurement of the at least one clear dimension, which is why the measurement can be carried out dynamically during their movement. This aspect further significantly increases the conveying density of the overhead conveyor system. However, it is also possible to measure the clear dimension between adjacent static, i.e. non-moving, overhead transport elements by means of the at least one sensor unit and to add tolerance values. Finally, it is particularly advantageous to measure both the static and dynamic spatial form of the clear dimension on a straight section of the trajectory, as the spatial shape of the clear dimension is not deformed there by the rotation of the overhead transport elements.

According to a further advantageous embodiment, it is provided that the at least one sensor unit is designed as at least one camera.

It is advantageous that the at least one sensor unit is mounted at an appropriate distance and at an appropriate height from the overhead conveyor in order, for example, to reproducibly measure the at least one clear dimension.

The advantages of the camera lie in the low price and the velocity of the measurement as well as the reliable usability.

According to a further advantageous embodiment, alternatively, or additionally, the at least one sensor unit is designed as at least one laser sensor.

The laser sensor provides accurate and robust measurements under various operating conditions. Furthermore, it is also possible to use a structured light scanner as at least one sensor unit in order to obtain an improved measurement.

According to a further advantageous embodiment, alternatively, or additionally, the at least one sensor unit is designed as an ultrasonic sensor.

In addition to the aforementioned advantages, the ultrasonic sensor works in all light conditions and offers accurate and fast measurement without the need for time-consuming calibration.

Particularly advantageously, the at least one sensor unit comprises a second computation unit.

The second computation unit is used, for example, to determine the at least one clear dimension minimum between adjacent overhead transport elements from the measured clear dimension, i.e. the distance.

A second aspect of the invention concerns a method for conveying overhead transport elements, in particular of an overhead conveyor.

A method according to the invention comprises the steps:
Detection of at least one distance between adjacent overhead transport elements and/or conveyor elements,
Optimization of the at least one distance between the adjacent overhead transport elements by means of at least one distance adjustment element.

The method according to the invention is advantageously carried out with a at least one distance optimization device according to the invention.

The method according to the invention can include further steps.

The method makes it possible to minimize the distances between overhead transport elements and/or overhead transport elements to a suitable value in order to increase the conveying density and, on the other hand, to determine sufficiently large distances in order to avoid collisions between individual overhead transport elements. This is advantageous in order to minimize the wear of these overhead transport elements and to reduce the risk of damage to the overhead items being transported in the overhead transport elements.

The solution according to the invention can also be supplemented and further improved by the following further embodiments, each of which is advantageous in its own right.

According to one advantageous variant of the method, a velocity of at least one overhead transport element is changed along a conveying direction of the overhead conveyor by means of the at least one distance adjustment element.

It should be noted that the at least one distance adjustment element can change the velocity in various ways. For example, the at least one distance adjustment element comprises a braking unit which decelerates the at least one overhead transport element. Alternatively, or additionally, the at least one distance adjustment element comprises a magnet unit which decelerates the at least one overhead transport element. It is also possible to adjust the velocity of at least one overhead transport element by means of a pneumatic cylinder or also by means of an electromechanical control element. By adjusting the pressure exerted by the cylinder, the velocity of the at least one overhead transport element can be increased or decreased, depending on whether the pressure is supplied along or against the conveying direction. It is also possible to use a brake or a stop element to reduce the velocity of the overhead transport element. A corresponding control can be mechanical or pneumatic, for example. A mechanical brake can consist of two brake linings that are brought into contact with each other and generate a resistance force that decelerates the at least one overhead transport element. A pneumatic brake can generate the braking force with the aid of compressed air in order to decelerate the at least one overhead transport element.

According to a further advantageous variant of the method, a velocity of at least one overhead transport element along the conveying direction of the overhead conveyor is controlled by at least one control unit.

This means that the conveying volume in the conveyor system can be regulated so that the quantity of overhead transport elements or overhead transport items can be easily adjusted.

According to a further advantageous variant of the method, the at least one control unit takes into account a velocity of at least one overhead transport element of the overhead conveyor.

This is advantageous because the at least one control unit has information about how high the input velocity of at least one overhead transport element is and can therefore also determine whether this velocity should be increased or decreased.

Alternatively, or additionally, in said advantageous variant of the method the at least one control unit takes into account the trajectory of the overhead conveyor.

Taking the trajectory of the overhead conveyor into account is advantageous because the optimum distances between adjacent overhead transport elements differ depending on where they are located on the conveyor section of the trajectory. For example, the optimal distances of a straight section of the overhead conveyor are no longer optimal for a curve along the trajectory, because overhead transport elements change their position there and therefore also the distances to each other. The extent to which the distances in a curve change compared to a straight section of the trajectory depends on the radius of the curve. It is therefore advantageous to take these parameters into account in that the at least one control unit also calculates the distances between adjacent overhead transport elements as a function of the trajectory and position of at least one overhead transport element and controls the distance adjustment element accordingly. Last but not least, it should be noted that the optimum distances of a straight section of the trajectory are not only influenced by a curve, but also by sections in which the height of the overhead transport elements changes, since their mutual position or distance is influenced due to the gradient of the conveyor sections. It is therefore advantageous if overhead transport elements are conveyed at different distances and velocities in these sections.

Alternatively, or additionally, in said advantageous variant of the method the at least one control unit takes into account at least one distance between adjacent overhead transport elements.

The at least one control unit should advantageously be connected to the at least one distance adjustment element for exchanging control data, since the velocity of the overhead transport elements is mainly adjusted by the at least one distance adjustment element.

In a particularly advantageous variant of the method, the at least one control unit takes into account the clear dimension minimum between adjacent overhead transport elements.

This means that the distance between adjacent overhead transport elements can be controlled based on the clear dimension minimum.

According to a further advantageous variant of the method, at least one detected distance is adjusted with a safety factor.

Even if the at least one control unit can take into account a large number of the parameters mentioned above in order to determine the optimum distance, it is advantageous to increase the optimized distance with a safety factor in order to reduce unexpected collisions between the overhead transport elements and thus reduce the risk of their wear or damage to the overhead transport items.

Furthermore, the safety factor can be used to additionally adjust the conveying density of the overhead conveyor.

For example, the safety factor can be reduced by the control unit, if necessary, in order to increase the conveying density exceptionally (in these special cases, possibly also by falling below the clear dimension minimum), even if this could lead to a statistically increased risk of failure. This risk is nevertheless advantageous in times of very high capacity utilization of the system, such as on peak processing days or weeks, when an excessively high number of overhead items are to be conveyed and the performance advantage created outweighs the risk of failure.

According to a further advantageous variant of the method, at least one sensor unit is provided.

With the aid of the at least one sensor unit, the at least one clear dimension can be recognized in order to obtain sensor data for setting an optimum distance from adjacent overhead transport elements.

The measurement of at least one clear dimension enables the recognition of information indicative of the distance between adjacent overhead transport elements, which can be used to determine their distance from one another in the at least one control unit.

Advantageously, the at least one sensor unit recognizes a dynamic spatial form of the overhead transport elements.

Alternatively, or additionally, a dynamic spatial form of the overhead transport elements is calculated by the control unit or the first computation unit.

The calculated spatial geometry makes it possible to determine the geometry of this overhead transport element, including its maximum dynamic deflections during conveying (including its enclosed items or its maximum volume), advantageously at least its swivel movements in and against the conveying direction.

Alternatively, or additionally, the at least one sensor unit recognizes at least one position of at least two adjacent overhead transport elements.

The detection of the position of at least two adjacent overhead transport elements comprises information indicative of the distance between adjacent overhead transport elements, with which their distance from one another can be easily determined in the at least one control unit.

A third aspect of the invention concerns an overhead conveyor system.

An overhead conveyor system according to the invention comprises at least one distance optimization according to the invention, wherein the at least one distance optimization device is arranged downstream of a loading station along at least one trajectory.

It is also advantageous to position the distance optimization device behind the compaction device.

The distance optimization device makes it possible to minimize the distances to a suitable value in the overhead conveyor system in order to increase the conveying density and, on the other hand, to determine sufficiently large distances in order to avoid collisions between individual overhead transport elements.

According to a further advantageous embodiment, operating parameters of the overhead conveyor system are sent to an AI (artificial intelligence) module.

Said AI module advantageously is designed in particular to optimize the conveying capacity and maintenance of the overhead conveyor system.

The operating parameters are, in particular, the number of overhead transport elements, their type, transport times and other data associated with the identification means, such as the time that an overhead transport element spends conveying different overhead transport items and its critical operating time, which determines the time at which its maintenance should be carried out. Additional parameters can be the type of overhead loads to be transported, their weight and dimensions. This is particularly advantageous because the AI module can use these parameters to optimize the conveying capacity of the overhead conveyor, the critical operating time of the overhead transport element, the planning of the overall maintenance of the overhead conveyor system or, for example, the wear of the overhead transport element.

As far as the wear of the overhead transport elements is concerned, the AI module can be connected to the loading station and optimize which overhead transport elements are to be loaded with which items such as goods. There are items that wear out the overhead transport elements more than others, for example those with sharp edges. It is therefore advantageous to distribute such overhead transport items over several overhead transport elements so that they are subject to wear as even as possible. This has the positive effect of preventing excessive wear of certain overhead transport elements, which could then require more frequent maintenance, which in turn can lead to more frequent system failures.

The AI module can also predict how long it will take for the overhead transport element to arrive at the unloading station. This is beneficial if certain types of overhead conveyed items that need to be transported faster than others are to be prioritized. In this scenario, it is also possible to predict which items should be stopped or delayed, in order to make room on the overhead conveyor for the higher priority overhead transport items. Priority should not only be seen as a binary variable, where 0 is normal priority and 1 is higher priority, but as a scale with several levels, e.g. from 0 to 10, where 0 is the lowest and 10 is the highest priority.

The AI module can also be used to further optimize the distance between adjacent overhead transport elements. Alternatively, or additionally, it can also be used to optimize the safety factor depending on the current utilization of the overhead conveyor.

It is further advantageous to create a digital twin of the overhead conveyor system using the first computation unit, which allows system simulation.

Accordingly, a digital twin of an overhead conveyor system is a digital representation of the physical conveyor system that is used to visualize, analyze and optimize the performance of the overhead conveyor system. The digital twin is created using data from the physical overhead conveyor system, including dimensions, component specifications and operating parameters, and is used to simulate the operation of the overhead conveyor system under different conditions and scenarios.

One of the main advantages of a digital twin is the better visualization and parameterization of the physical overhead conveyor system. By creating a 3D representation, users can visualize and optimize the different components and their relationships to each other. This can also be useful for troubleshooting, training and maintenance. Another advantage of a digital twin is its ability to improve and optimize the capacity of the overhead conveyor system through simulation and analysis. This can further help to improve the efficiency and reliability of the overhead conveyor system. In addition to simulation and analysis, a digital twin can also be used for real-time monitoring and diagnosis of the overhead conveyor system. By linking the digital twin with sensors and other data sources, users can obtain real-time data on the operation of the overhead conveyor system. This can help to identify and resolve problems and performance bottlenecks more quickly, as well as minimize downtime and other disruptions. Another benefit of the digital twin is its ability to optimize collaboration between operators. Because the digital twin can be accessed and shared by multiple users from different locations, team members can collaborate more effectively and make more informed decisions about the operation and optimization of the overhead conveyor system. Finally, a digital twin can also be used to improve the condition monitoring of the overhead conveyor system.

Using the digital twin, it is possible to simulate the overhead conveyor system comprising at least one distance optimization device with software. This simulation is advantageous because it allows data to be collected about the entire overhead conveyor system, which can accelerate and improve the training of the AI module. Depending on these operating parameters, it is then possible to optimize the performance of the overhead conveyor or, for example, the optimal conveyor route for transporting overhead transport elements with different priorities. This data can then be used to train the AI module according to the principle of supervised learning as a substitute model that can be used in online operation, as simulation models are usually slow.

As an alternative solution, the principle of reinforcement learning can be used, in which the overhead transport elements are treated as agents and the rest of the suspension transport system as the environment.

The agents interact with the environment and try to achieve the highest possible reward as part of a so-called reward function. In this case, the reward function could be the maximum conveying density, the minimization of the maintenance requirements of the various components, and the efficient prioritization of the overhead transport elements.

Advantageously, the overhead conveyor system is designed in a flexible and modular way.

A flexible overhead conveyor system is a transportation and logistics solution that is designed to be portable, versatile, easy to set up and can be used in a variety of environments. The overhead conveyor system consists of a series of modular components, including conveyor belts, carriers and drive systems, which can be easily assembled and disassembled without the need for special tools or equipment. One of the most important advantages of a flexible overhead conveyor system is its transportability. The overhead conveyor system can be easily transported to different locations and assembled on site, making it suitable for use in temporary or transient installations. By using telescopic or extendable sections or adjustable brackets, the overhead conveyor system can be reconfigured as required, and the control system according to the invention allows optimization of the conveying density in these cases as well.

Another important benefit associated with a flexible overhead conveyor system is the control and automation functions described above. Sensors, controllers and software can be used to enable automatic routing, real-time monitoring and diagnostics, and connectivity with other logistics systems. In this way, the conveyor can be programmed and customized to the specific requirements of each application, improving operational efficiency and accuracy.

### BRIEF DESCRIPTION OF SEVERAL VIEWS OF THE DRAWINGS

In order to facilitate a fuller understanding of the present invention, reference is now made to the appended drawings. These references should not be construed as limiting the present invention but are intended to be exemplary only. Components that are identical, or that are identical at least in terms of their function, are designated below by identical or at least comparable reference numbers

FIG. 1 schematically shows a top view of an overhead conveyor system according to the invention;

FIG. 2 schematically shows a side view of an overhead conveyor system according to the invention;

FIG. 3 schematically shows a top view of a distance optimization device according to the invention in the overhead conveyor system shown in FIG. 1;

FIG. 4 schematically shows, from top to bottom, a top view of overhead transport elements at a standstill, a side view of said overhead transport elements at a standstill, and a side view of said overhead transport elements in motion;

FIG. 5 schematically shows a perspective view of a plurality of empty overhead transport elements in a storage area for an overhead conveyor system as shown in FIG. 1;

FIG. 6 schematically shows a side view of a loaded overhead transport elements according to FIG. 4 or FIG. 5;

FIG. 7 schematically shows a flow diagram of the process for an overhead conveyor system according to the invention;

FIG. 8 schematically shows a top view of overhead transport elements in a curve;

FIG. 9 schematically shows a side view of a loaded overhead transport element in various swivel positions (a-c);

FIG. 10 schematically shows a side view of connected overhead transport elements in two different orientations, and

FIG. 11 schematically shows a side view of connected overhead transport elements in the same orientation.

### DETAILED DESCRIPTION OF THE INVENTION

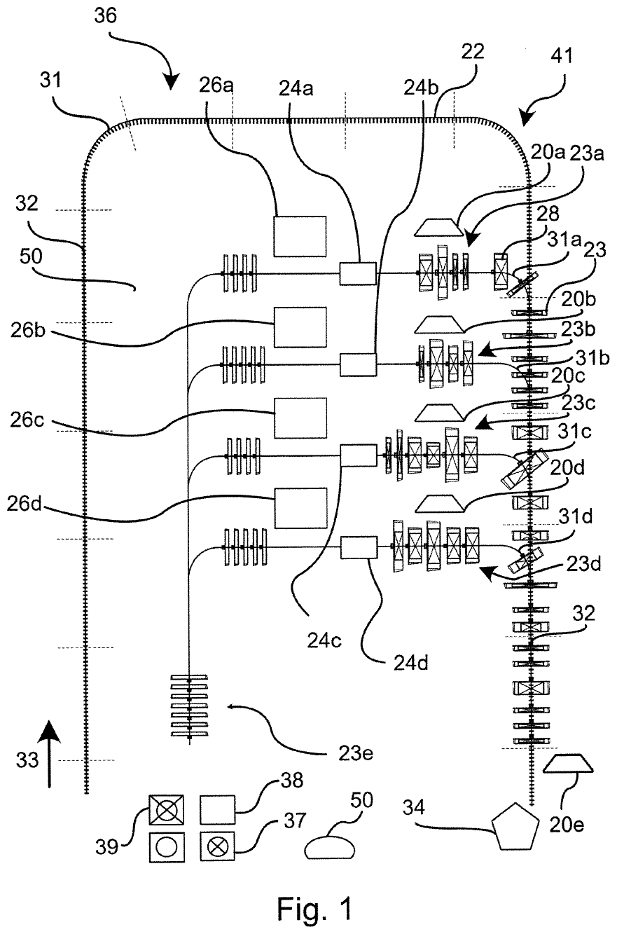

FIG. 1 shows an overhead conveyor system 36 with its functional elements in a schematic plan view. This overhead conveyor system 36 includes an overhead conveyor 22, as known for example from the overhead conveyor system according to CH 714004 A1 of the present applicant, which is used for the transportation of overhead transport elements 23. Furthermore, the overhead conveyor 22 is defined by its conveying velocity and trajectory 41. The conveying process begins with empty overhead transport elements 23e, which are transported to four separate loading stations 26a-26d at uniform intervals in the conveying direction 33. There they are loaded with different overhead conveyed items 28. If an overhead transport item 28 comprises garment elements, these are transported on a hanger, otherwise in a transport bag. It should be mentioned that the loading process leads to a change in the size or dimensions of the overhead transport elements 23 compared to their empty state.

Loaded overhead transport elements 23 are released at the same or different distances from the loading stations 26a-26d, whereby collisions must be avoided at this point. In addition, the type of overhead transport element 23 is taken into account, i.e. whether an overhead transport element 23 is a hanger or a transport bag. Then, optionally, the spacing of overhead conveyed items 28 in the overhead transport elements 23 is optimized by means of compaction devices 24a-24d (compacted by brushing or vibrating, for example). It could otherwise happen during the subsequent conveying that the overhead transport items 28, which are located in, at or on overhead transport elements 23, move spatially, as a result of which the distances between adjacent overhead transport elements change, which is generally undesirable. After this compaction, the spacing is adjusted by means of distance optimization devices 20a-20d.

In this example, these are implemented as buffer and separation units with stop/release elements that are electrically controlled by a programmable logic controller 39 (PLC) on the basis of the minimum distance value measured by a camera and determined by software. The distance optimization devices 20a-20d release the overhead transport elements 23a-23d in a controlled manner, individually and at predetermined distances optimized for the downstream transport area. Since additional overhead transport elements 23 are sorted into the circulating overhead conveyor 22 at the various switch points (curves 31a to 31d), the higher-level control unit 39 takes this situation into account and keeps the necessary gaps or free positions free when the distance optimization devices 20a-20d are dispensed.

In addition, the loaded overhead transport elements 23 are prioritized by loading station. Thus, the loading stations 26a-26b have a higher priority than the loading stations 26c-26d, so that the overhead transport items 28 loaded in overhead transport elements 23a-23b of the prioritized loading stations 26a-26b are conveyed faster, because the other loading stations 26c-26d free up space for them on the overhead conveyor 22. This is achieved by stopping the overhead transport elements 23c-23d. The setting and priority is carried out via an AI module 50, which is connected to a first computation unit 37. The AI module 50 determines which overhead transport elements 23 are to be stopped or accelerated so that those with a higher priority are transported earlier. The priorities of the overhead transport elements can be adjusted at any time.

After the overhead transport elements 23 have moved further along the curves 31a-31d and are in the straight section 32 of the overhead conveyor 22, they are again adjusted by another distance optimization device 20e in order to optimize the distance with respect to the further trajectory 41 and to increase or, if necessary, reduce the conveying density of the overhead conveyor 22 by increasing the distances. It should be mentioned that due to the consideration of the trajectory 41 of the overhead conveyor 22 for the distance adjustment, the determined distances would be different if there were no curves 31a-31d behind the distance optimization devices 20a-20d (other than provided here). Finally, the conveying process ends at an unloading station 34, e.g. a packaging or shipping area.

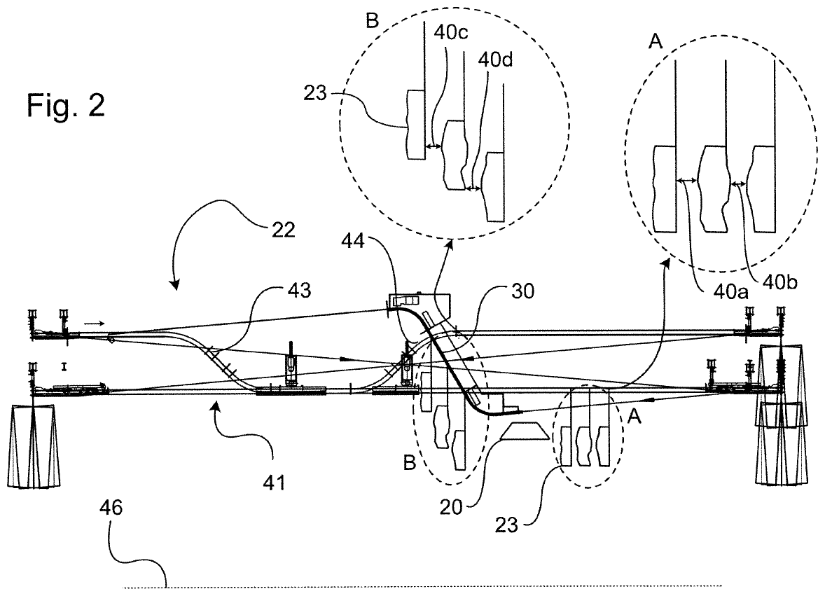

FIG. 2 shows a schematic side view of an overhead conveyor 22 according to the invention. In particular, overhead transport elements 23 can be seen here, which move along various sections of a trajectory 41 of the overhead conveyor 22. Two illustrated overhead transport elements 23 are transport bags with a fixed bottom and a fixed back part. The remainder of the bag is made of a flexible material that can adapt to the shape of the overhead transport items 28 loaded into the transport bag. The third overhead transport element 23 is designed such that it also has a back made of flexible material. In addition, the trajectory 41 in this embodiment consists of several height-variable sections 30 in which the overhead transport elements 23 change their conveying height relative to the floor 46 (indicated by the dotted line in FIG. 2). These are realized by a descent section 43 and an ascent section 44.

The loaded overhead transport elements 23 on a straight section of the trajectory 41 have optimized distances depending on a measured clear dimension 42, a certain clear dimension minimum 40a-40d, a velocity and acceleration of the overhead conveyor 22, and a position of the overhead transport element 23 (see clear dimension minima 40a, 40b in enlarged detail A). Nevertheless, when the overhead transport elements 23 enter the ascent section 44 of the trajectory 41, the distance between the overhead transport elements 23 should be adjusted again, since the clear dimension minimum 40a-40d changes due to the vertical displacement of the overhead transport elements 23 relative to each other (see changed clear dimension minima 40c-40d in enlarged detail B).

This adjustment is carried out by means of a distance optimization device 20. In addition, when optimizing the distances, the swaying of the overhead transport elements 23 by entering the ascent section 44 and therefore changing the trajectory 41 is also taken into account, namely with a first computation unit 37. The first computation unit 37, for example implemented as an Arduino with corresponding software, also multiplies distances by a safety factor of 1.15, advantageously 1.15 to 1.3, in order to minimize the risk of a collision.

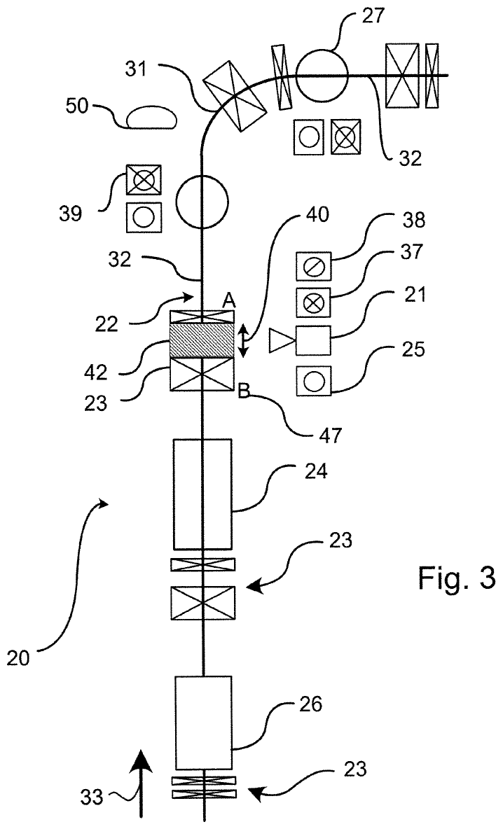

FIG. 3 shows a schematic top view of a distance optimization device 20. The distance optimization device 20, which includes a sensor unit 21, a control unit 39 and a distance adjustment element 27, serves according to the invention as additional equipment of an overhead conveyor 22. The control unit 39 is designed to control the at least one distance adjustment element 27 on the basis of measurements by the at least one sensor unit 21 of the free space between two adjacent overhead transport elements 23, so that the distance between the adjacent overhead transport elements 23 is adjusted in an adaptable and parameterized manner. The overhead conveyor 22 is also equipped here with a compaction device 24. The conveying process, the conveying direction 33 of which is determined by an arrow, begins at a loading station 26, where two empty overhead transport elements 23 are loaded with overhead transport items 28. The loading then changes the dimensions of the overhead transport elements 23 and thus the clear dimension 42 between them (indicated by hatching). A clear dimension minimum 40 between adjacent overhead transport elements 23 is also determined here. The clear dimension 42 is measured by means of the sensor unit 21, which is designed as a camera in this embodiment. The measurement is regarded as an input to a second computation unit 38, which determines the clear dimension minimum 40 from the measured clear dimension 42. In addition, the second computation unit 38 is designed as a computer with corresponding software. The determined clear dimension minimum 40 is considered to be the distance between the two adjacent overhead transport elements 23 and is optimized, namely by means of a first computation unit 37 which, in addition to the dynamic spatial form of the two overhead transport elements 23, takes into account additional parameters such as the velocity of the overhead transport elements 23, a trajectory 41 of the overhead conveyor 22 and positions of the overhead transport elements 23 on the trajectory 41. In this case, a curve 31 is taken into account in particular and the distances are optimized accordingly with regard to this curve 31, with the aim of increasing the conveying density on the one hand and reducing or eliminating the risk of collision between the adjacent overhead transport elements 23 on the other. It should also be noted that the optimization can both increase and decrease the distance between adjacent overhead transport elements 23 in a controlled manner depending on the parameters mentioned. Part of the optimization is also the optional multiplication of the distance by a safety factor of 1.1.

If the dynamic spatial form is to be measured directly by means of the sensor unit 21 (and not calculated by the control unit 39 or the computation units 37, 38), the measurement can be arranged specifically in a critical conveying area where inherent movements of the overhead transport element 23 occur or a correspondingly special trajectory 41 is provided. Alternatively, various inherent movements of the overhead transport element 23 can be specifically triggered at a defined measuring point in order to determine the parameters of the dynamic spatial form to be measured there or to determine them based on the dynamics. For this purpose, the sensor unit 21 can advantageously be one or more light measurement grids, an ultrasonic distance sensor or even a 3D laser scanner, which detects the extreme values or the maximum deflections of the overhead transport element to be measured.

At the same time as the distance between adjacent overhead transport elements 23 is determined, each overhead transport element 23 is assigned an identification feature 47 by means of an identification means 25. In this embodiment, each overhead transport element 23 is marked with an RFID tag, which is read by the identification means 25. A unique identification feature 47 is then uploaded to this RFID tag. Thus, the first overhead transport element along the overhead conveyor 22 is marked as A, and the second as B. In addition, distances to a leading and trailing hand transport element 23 are assigned to each of these identification features 47. Accordingly, the digital information of the first overhead transport element 23 (with example dimensions) is as follows:

Identification feature 47: A, distance to the leading overhead transport element 23: 0 mm, distance to the trailing overhead transport element 23 250 mm.

The distance to the leading overhead transport element 23 is 0 mm because it is the first overhead transport element 23. This information is stored on the control unit 39 so that it can always be called up if required. The information about the distance to adjacent overhead transport elements 23 is also received by a control unit 39 designed here as a programmable logic controller (PLC). addition, it has the information about the value to which the distance between adjacent overhead transport elements 23 of the overhead conveyor 22 is to be adjusted, which is 300 mm in this embodiment. As already mentioned, this value depends on the position of the overhead transport element 23 on the trajectory 41 of the overhead conveyor 22 and its velocity and is determined by means of the first computation unit 37. Furthermore, it should be noted that the critical curve distance 49 between adjacent overhead transport elements 23 is 250 mm due to their mutual rotation.

The distance adjustment element 27 controlled by the programmable logic controller is designed as a pneumatic cylinder with a mechanical brake that either stops the overhead transport elements 27 and releases them again at appropriate time intervals or shifts them by a certain distance so that the distances are changed to their optimized values in a controlled manner. Thus, in this embodiment, the distance between adjacent overhead transport elements 23 should be increased by 50 mm from 250 to 300 mm. Since the velocity of the second overhead transport element 23 is 350 mm/s, the second overhead transport element 23 is held for 0.14 seconds by means of the mechanical brake, so that the distance between them is increased to 300 mm.

After the curve 31, a next distance optimization takes place, which now takes place without measurements, because thanks to the information stored in the control unit 39 (or alternatively also the computer device), the current distances between the adjacent overhead transport elements 23 are known. Since the overhead transport elements 23 are now located in the straight section 32 of the trajectory 41 of the overhead conveyor 22 at a velocity of 350 mm/s, the first computation unit 37 determines that the optimized distance at which the conveying density is increased, but at the same time the risk of collisions between adjacent overhead transport elements 23 is minimized, is 250 mm. It also calculates that the compressed air cylinder controlled by the programmable logic controller 39 should move the second overhead transport element 23 by 50 mm, so that the distance is reduced from 300 mm to 250 mm.

Finally, the optimal maintenance of the overhead transport elements 23 is optimized by an AI module 50, depending on the overhead transport items 28 carried in the individual overhead transport elements 23. For example, overhead transport element 23 A carries overhead transport items 28 with sharp edges, whereas overhead transport element 23 B does not. During the next loading, the AI module 50 will therefore attempt to load potentially sharp-edged hanging transport items 28 into the hanging transport element 23 B. This leads to an even distribution of wear on the overhead transport elements 23 and to a lower risk of failure of the entire overhead conveyor system 36 as a result of damage to or destruction of the overhead transport element 23.

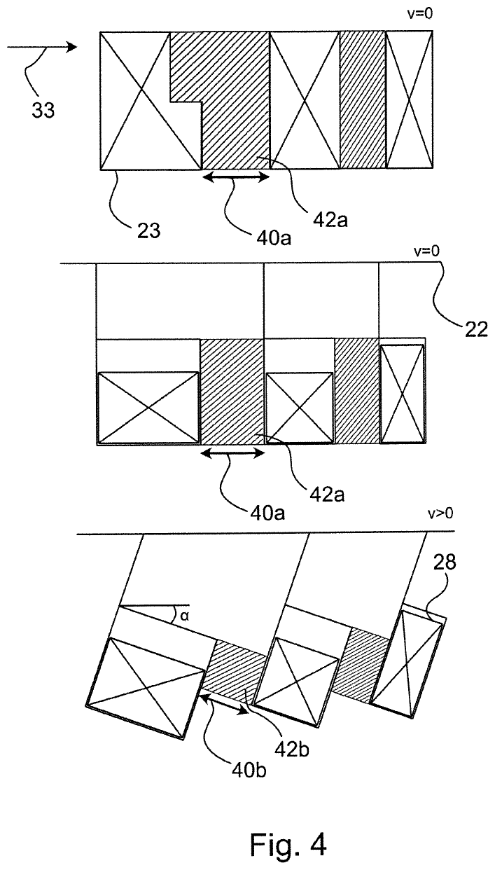

FIG. 4 shows a schematic top and side view of the overhead transport elements 23 at a standstill and a schematic side view of the overhead transport elements 23 in motion. The conveying direction 33 of an overhead conveyor 22 is indicated by an arrow. In addition, the clear dimensions 42a, 42b between adjacent overhead transport elements 23 are illustrated with a hatching.

The clear dimension minimum 40a is regarded as a clear dimension minimum value or minimum value distance between two adjacent overhead transport elements 23 and is designated here as a distance that is further optimized. In the side view, it can be seen that a sensor unit 21 (not shown here), in this case the camera, only measures part of the clear dimension 42a between adjacent overhead transport elements due to the viewing direction from the front. However, since a clear dimension minimum 40a is sought, this does not play a role here. It is important to mention that the first two views depict overhead transport elements 23, which have a velocity of zero here and consequently the clear dimension 42a between them has a static spatial form. This changes in the third schematic side view, where the velocity of the overhead transport elements 23 is greater than zero. This causes an inclination of the overhead transport elements 23, which also leads to a deformed clear dimension 42b, which now takes into account a dynamic spatial form. The tilt rate is defined by the alpha angle and affects the clear dimension minimum 40b according to the following equation:

$$40 b = 40 a * function of cos ( alpha )$$

This equation shows that the greater the alpha angle, which regularly increases with increasing velocity, the smaller the clear dimension minimum 40b. It is obvious to the person skilled in the art that this equation can advantageously take into account further or alternative functional parameters (such as acceleration or convex surface areas in particular), which allow the calculation of the clear dimension minimum 40b, making it possible to determine the clear dimension minima even more precisely. In this case, the formula is 40b=40a*function (at least one light amplitude or clear dimension minimum parameter). Taking this into account, it is possible to measure the dynamic shape of the clear dimension 42b and use it to determine its clear dimension minimum 40b, which can then be calculated as a function of the velocity of the overhead transport elements 23, if necessary, which increases the conveying density of the overhead conveyor 22, as they do not have to be stopped.

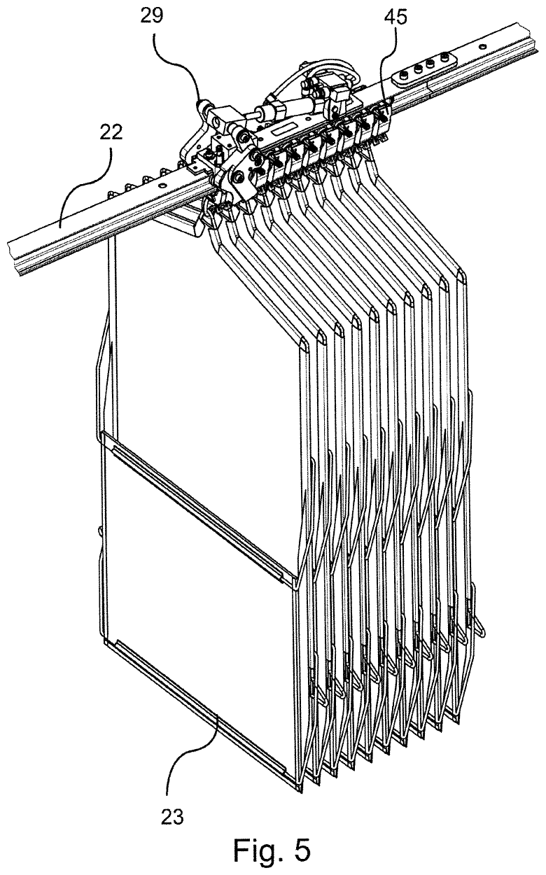

FIG. 5 shows a plurality of empty overhead transport elements 23. The overhead transport elements 23 shown are empty and therefore do not contain any overhead transport items 28. In addition, they are connected to an overhead conveyor 22 via a conveyor element 45 so that they can be conveyed. Above the overhead conveyor 22, a separation unit 29 can be seen with a stop element, as is known to the skilled person, and which allows the overhead transport elements to be buffered and released.

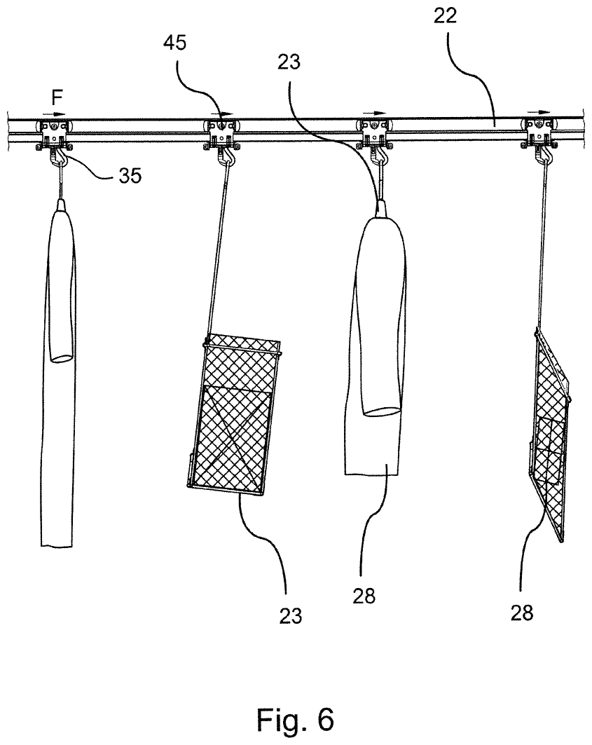

FIG. 6 shows a schematic side view of loaded overhead transport elements 23, which are shown as either transport bags or hangers. Therefore, the overhead transport elements 23 can be used for the transportation of various overhead transport items 28, such as items and clothing, by means of the overhead conveyor 22. Furthermore, the overhead transport elements 23 are connected to the overhead conveyor 22 via a conveyor element 45 so that they can be conveyed or transported. The conveying direction 33 is in the direction of the arrows F. The overhead transport elements 23 or overhead transport items 28 are detachably connected to the conveyor elements 45 via adapter elements 35. In this embodiment, the adapter elements 35 are designed as eyelets into which clothes hangers or transport bags shown can be hooked. If overhead transport items 28 are coupled directly to the adapter elements 35, they are together to be under-stood as overhead transport elements 23.

The adapter elements 35 are advantageously controllable so that they enable the release of conveyed items in the desired processing steps or the discharge of items in fault situations. Control can take place via the control unit 39 or also locally via control cams or local control units. It is particularly advantageous if the control unit 39 can be used to enable local optimization of the conveying distance. In this way, for example, empty overhead transport bags or other overhead transport elements 23 can be dispensed along a conveyor section, thereby achieving an additional increase in the conveying density. The distance can be reduced in this way by reducing the distance between the leading and trailing overhead transport elements 23 with respect to the discharged overhead transport elements 23 in a controlled manner. This effect can be used to advantage even if overhead transport elements 45 without transported items lie between them, since the dimensions of the overhead transport elements 45 are generally comparatively small compared to the overhead transport elements 23 or items. These adapter elements 35 can be fitted again in subsequent conveyor sections.

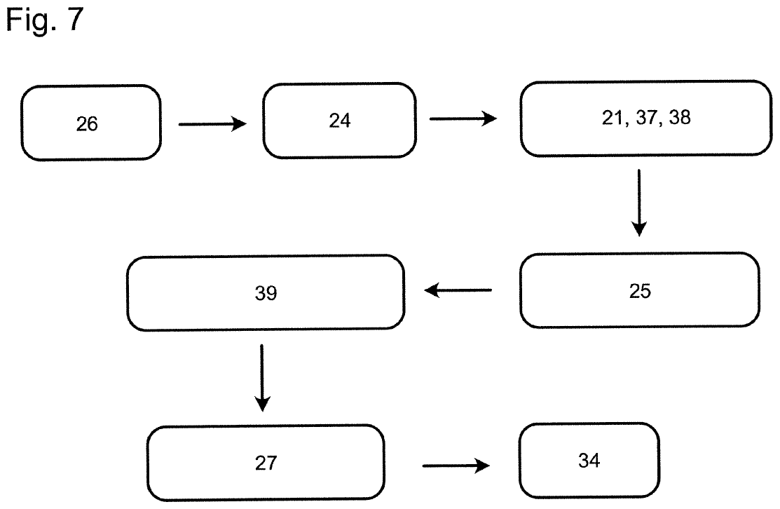

FIG. 7 shows a flow diagram of the process of overhead transport elements 23. The process begins at a loading station 26, where overhead transport elements 23 are loaded with overhead transport items 28. A compaction device 24 shown here can then be provided, with which the positions of the items in the overhead transport elements 23 are influenced and optimized.

A clear dimension 42 between adjacent overhead transport elements 23 is then measured by a sensor unit 21 and a second computation unit 38 is used to determine a clear dimension minimum 40 as the optimized distance between adjacent overhead transport elements 23. In addition, a first computation unit 37 is provided, which additionally optimizes the distance between adjacent overhead transport elements 23 as a function of a trajectory 41 of the overhead conveyor 22 and of the velocity of the overhead transport elements 23, if required.

Moreover, each overhead transport element 23 is optionally assigned at least one identification feature 47 by means of an identification means 25. The determined distance is then optimized with the aid of a distance adjustment element 27, which is controlled by a control unit 39. Finally, the entire process is completed at an end point, in this case an unloading station 34.

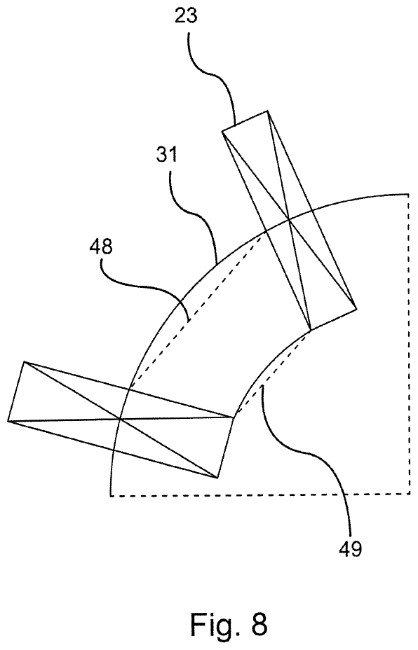

FIG. 8 shows a schematic top view of the overhead transport elements 23 in a curve 31. The curve distance 48 corresponds to a clear dimension minimum 40 determined by a second computation unit 38 and from a straight section 32, which has been further optimized by a first computation unit 37. It should be noted that the mutual rotation of the overhead transport elements 23 brings them close to a value that is smaller than the curve distance 48. This value is referred to as the critical curve distance 49 and has been taken into account by the second computation unit 38 when determining an optimized distance in the curve 31, since the overhead transport elements 23 are closest to each other at this critical curve distance 49 and there is therefore the greatest risk of collision here.

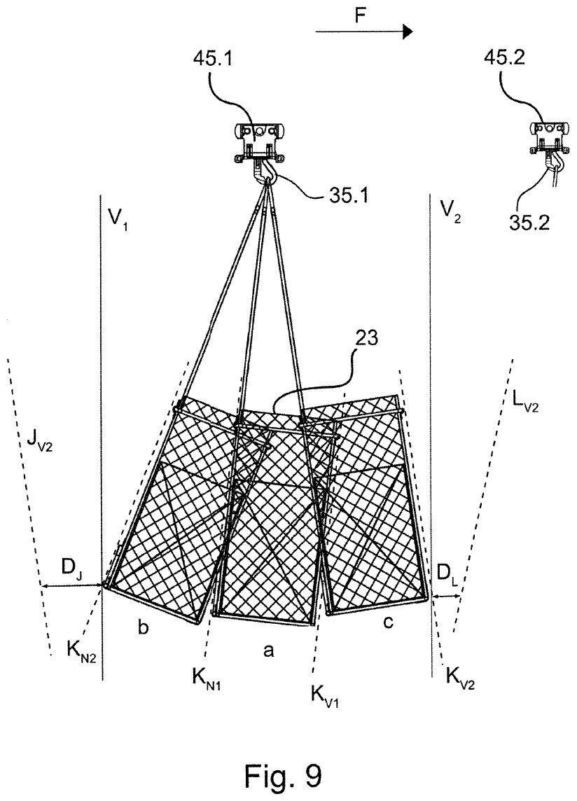

FIG. 9 illustrates the above-mentioned dynamic spatial form and its use for the control unit 39 according to the invention in more detail. A first overhead transport element 23 is recognizable, conveyed by a first conveying element 45.1. In a (static) overhead position, this overhead transport element 23 assumes the position a, i.e. its center of gravity (including any items or items conveyed therein) lies essentially vertically below the adapter element 35.1. The maximum forward swivel position of the overhead transport element in the conveying direction F is determined by means of sensors, previously known data (historical data) or on the basis of default values according to database values. This position is marked with c. The maximum overrun swivel position, marked b here, is determined in the same way.

The extreme values of the overrun swivel position, which is indicated here by the dashed auxiliary plane KN2, are determined with reference to a vertical plane V1 that is perpendicular to the conveying direction F and for the overrun swivel position or the auxiliary plane KV2 with reference to a corresponding vertical plane V2 that is also perpendicular to the conveying direction F. In this model example, the two auxiliary planes KV1 and KV2 are arranged perpendicular to a vertical plane running in the conveying direction. In this typical example, the dynamic spatial form comprises the spatial area between the auxiliary levels V1 and V2, whereby the space in the vertical direction is of course only to be taken into account for the height of the overhead transport element 23 or, in any case, at most from the area of the adapter element 35.1 to the lowest-lying area of the overhead transport element 23.

It is obvious to the person skilled in the art that the extreme values (leading and trailing) can be determined not only for the pivoting shown here, but also for twisting or tilting in the same way. In this case, the auxiliary planes KV1 and KV2 are no longer perpendicular to a vertical plane running in the conveying direction F but are geometrically rotated by an angle in two directions to determine these extreme values. The extreme values in the conveying direction (leading and trailing) are thus determined in the same way for such twisting movements. This results in a dynamic spatial form that is no longer essentially cuboid but is more complex due to the additional geometry determination. Depending on the computing power of the control unit 39 or the available database, all spatial movements of an overhead transport element 23 can be calculated or determined in this way. If tilting and twisting movements are taken into account in addition to the swivel movement shown here to determine the extreme values, the spatial shape is no longer limited by two planes V1, V2, but by curved or kinked surfaces in the forward and backward directions. The dynamic spatial form determined in this way thus encloses a spatially limited volume, whereby only the boundary surfaces in the leading and trailing directions need to be considered in order to optimize the conveying density. In the simplest case, as shown in the example, these are the two limiting planes V1, V2.

As can also be seen in FIG. 9, the dynamic spatial form of a second downstream overhead transport element 23, which is conveyed on an adapter element 35.2 shown here, is determined in the same way. Its trailing boundary is indicated here by the auxiliary plane LV2. In the same way, the dynamic spatial form is determined for an upstream overhead transport element (not shown here). The minimum distance required in the conveying direction F is now calculated for each of these two adjacent overhead transport elements 23 (clear dimension minimum), which is marked here with the two double arrows DL and DJ. In this way, disruptive collisions between the overhead transport elements 23 can be avoided and the conveying density optimized.

A safety value can be added to this distance for special applications. The corresponding values are calculated by the control unit 39 or the computer device 37 from the measurement data of the sensor unit and/or other control information (e.g. historical data or advantageously default data for the overhead transport elements).

As described, the control unit 39 (not shown here) thus determines the dynamic spatial form for a first overhead transport element 23 and for its adjacent overhead transport elements 23 (leading and trailing) and then determines (for the vertical area between the adapter element 35 and the lowest lying area of the respective overhead transport elements 23) the minimum distance DL and DJ (clear dimension minimum 40) between them, taking into account the opposing leading and trailing surfaces of the dynamic spatial form. Based on the minimum distance calculated in this way between each two adjacent overhead transport elements 23, the distance between these or between the respective conveyor units 45.1 and 45.2 is set. As mentioned, a safety value (tolerance) can be added to the values DL and DJ.

This shows that the dynamic spatial form comprises the geometry of the overhead transport element 23, including its maximum deflections, advantageously the swivel movements in and against the conveying direction F. The outer surface of the dynamic spatial form determined in this way for each two adjacent overhead transport elements 23 defines the clear dimension 42 between them. The clear dimension minimum 40 for the adjacent overhead transport elements 23 can be determined in this way and also optimized as a function of the respective downstream sections of the respective conveyor sections.

Alternatively, in less complex circumstances, it is also possible to measure the clear dimension 42 between adjacent static, i.e. non-moving, overhead transport elements 23 by means of a sensor unit 21 only at one or a few (typically most deflecting) points in the center or floor area of overhead transport elements 23 and to use this (approximate) value for the minimum distance as the clear dimension minimum 40.

In alternative embodiments, in further simplification, the distance between the overhead transport elements 45 or the adapter elements 35 can be measured upstream of a distance optimization device 20 and their distance can be adjusted based on database values to the clear dimension 42 for conveying and thus set in a parameterized manner.

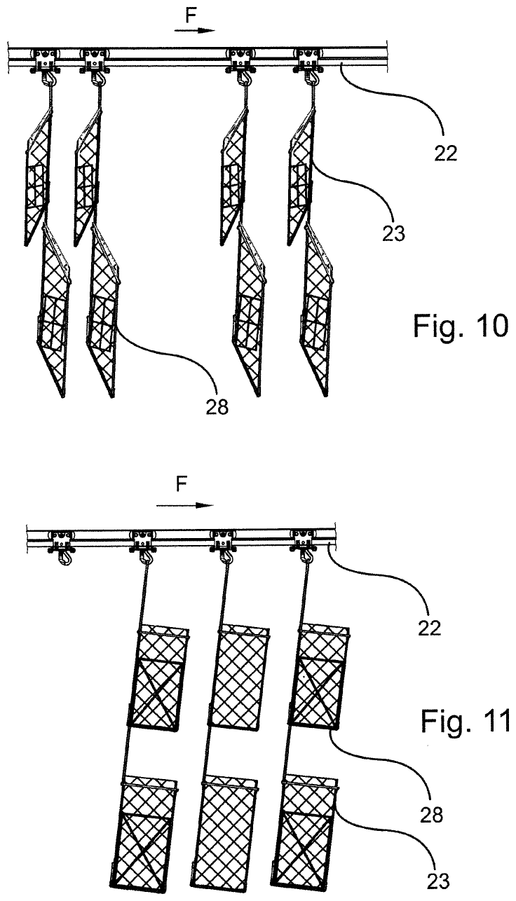

FIGS. 10 and 11 show the connection of the overhead transport elements 23, which are overhead in two rows. In the first variant shown in FIG. 10, each row of the overhead transport elements 23 has a different orientation, whereas in FIG. 11 this orientation is the same for both rows of the overhead transport elements 23.

The present invention is not to be limited in scope by the specific embodiments described herein. Indeed, various modifications of the present invention, in addition to those described herein, will be apparent to those skilled in the art from the foregoing description and accompanying drawings. Thus, such modifications are intended to fall within the scope of the appended claims.

Additionally, various references are cited throughout the specification, the disclosures of which are each incorporated herein by reference in their entirety.

1. A distance optimization device for overhead transport elements within an overhead conveyor, comprising:
at least one sensor unit,
at least one distance adjustment element, and
at least one control unit,
wherein the at least one control unit is designed to control the at least one distance adjustment element on the basis of measurements by the at least one sensor unit of the free space between two adjacent overhead transport elements, so that the distance between the adjacent overhead transport elements is adjusted in an adaptable and parametrized manner.

2. The distance optimization device according to claim 1, wherein the at least one sensor unit is designed to measure at least one clear dimension between adjacent overhead transport elements.

3. The distance optimization device according to claim 2, wherein the at least one clear dimension minimum between adjacent overhead transport elements is a minimum value distance between said adjacent overhead transport elements.

4. The distance optimization device according to claim 1, wherein the at least one sensor unit is designed to determine at least one position of at least two adjacent overhead transport elements and/or conveyor elements.

5. The distance optimization device according to claim 1, wherein at least one compaction device is provided.

6. The distance optimization device according to claim 5, wherein the at least one compaction device is positioned in front of the at least one sensor unit along a conveying direction of the overhead conveyor.

7. The distance optimization device according to claim 1, wherein at least one identification means is provided, and wherein the at least one identification means assigns at least one identification feature to at least one overhead transport element or conveying element along a conveying direction of the overhead conveyor.

8. The distance optimization device according to claim 7, wherein the at least one identification means assigns to at least one identification feature of the overhead transport element or conveying element a distance to at least one adjacent overhead transport element.

9. The distance optimization device according to claim 1, wherein at least one distance, in particular the clear dimension minimum, between adjacent overhead transport elements and/or conveyor elements is dependent on a trajectory of the overhead conveyor.

10. The distance optimization device according to claim 1, wherein a first computation unit is provided.

11. The distance optimization device according to claim 10, wherein the first computation unit is designed to calculate at least one optimized distance based on a trajectory of the overhead conveyor, and/or a velocity of at least one overhead transport element.

12. The distance optimization device according to claim 1, wherein the at least one sensor unit is designed to detect a dynamic spatial form of the overhead transport elements.

13. The distance optimization device according to claim 1, wherein a dynamic spatial form of the overhead transport elements is calculated by the control unit or the first computation unit.

14. The distance optimization device according to claim 1, wherein the at least one sensor unit is designed to include at least one of at least one camera, at least one laser sensor, and at least one ultrasonic sensor.

15. The distance optimization device according to claim 14, wherein the at least one sensor unit comprises a second computation unit.

16. A method for conveying overhead transport elements within an overhead conveyor, comprising the method steps:
detecting at least one distance between adjacent overhead transport elements and/or conveyor elements,
optimizing the at least one distance between the adjacent overhead transport elements by means of at least one distance adjustment element.

17. A method for conveying overhead transport elements within an overhead conveyor, comprising the method steps:
detecting at least one distance between adjacent overhead transport elements and/or conveyor elements,
optimizing the at least one distance between the adjacent overhead transport elements by means of at least one distance adjustment element, wherein the method is carried out with at least one distance optimization device according to claim 1.

18. The method according to claim 16, wherein a velocity of at least one overhead transport element along a conveying direction of the overhead conveyor is changed by the at least one distance adjustment element.

19. The method according to claim 16, wherein a velocity of at least one overhead transport element along a conveying direction of the overhead conveyor is controlled by at least one control unit.

20. The method according to claim 19, wherein the at least one control unit takes into account the velocity of at least one overhead transport element of the overhead conveyor and/or a trajectory of the overhead conveyor and/or at least one distance of a clear dimension minimum, between adjacent overhead transport elements.

21. The method according to claim 16, wherein at least one detected distance is adjusted by a safety factor.

22. The method according to claim 16, wherein at least one sensor unit is provided and detects a dynamic spatial form of the overhead transport elements.

23. The method according to claim 16, wherein a dynamic spatial form of the overhead transport elements is calculated by the control unit or a first computation unit.

24. An overhead conveyor system comprising at least one distance optimization device according to claim 1, wherein the at least one distance optimization device is arranged downstream of a loading station along at least one trajectory.

25. The overhead conveyor system according to claim 24, wherein operating parameters of the overhead conveyor system are sent to an artificial intelligence module, the artificial intelligence module designed to optimize the conveying capacity and maintenance of the overhead conveyor system.
